(19) United States
(12) Patent Application Publication
(10) Pub. No.: US 2010/0172626 A1
(43) Pub. Date: Jul. 8, 2010

(54) Trick Mode Based Advertisement Portion Selection

(75) Inventors: Victor S. Lee, Cupertino, CA (US); Pradip K. Fatehpuria, San Jose, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/349,645

(22) Filed: Jan. 7, 2009

(51) Int. Cl. H04N 5/91; H04N 7/00

(52) U.S. Cl. 386/68; 725/32; 386/E05.028

(57) ABSTRACT

Programming content is played back in a trick mode. One or more portions of an advertisement to be played back are identified based at least in part on the trick mode. These one or more portions are less than the entire advertisement, and are played back during an advertising segment. Playback of the programming content in the trick mode resumes after the advertising segment ends. A table or other record associated with the advertisement can be stored to maintain identifications of the one or more portions for each of multiple trick modes.

### BACKGROUND

Current video playback systems typically allow consumers to rewind or fast-forward through television programming and other audio/video content. This ability to fast-forward and/or rewind can be performed at different speeds, and these are oftentimes referred to as trick modes. However, the use of such trick modes can create problems for advertisers. Depending on the speed at which the trick mode is running, an advertisement may be passed over very quickly by a user. This can be problematic as it can result in an advertisement that provides very little information to the user and creates very little value for the advertiser.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, programming content is played back in a trick mode. One or more portions of an advertisement to be played back are identified based at least in part on the trick mode. These one or more portions are less than the entire advertisement, and are played back during an advertising segment. Playback of the programming content in the trick mode resumes after the advertising segment ends.

In accordance with one or more aspects, an identification of a trick mode is received. An identification of one or more portions of an advertisement to be played back for the trick mode is also received. A record of the one or more portions for the trick mode for the advertisement is stored. This receiving an identification of a trick mode, receiving an identification of one or more portions, and storing a record is then repeated for one or more additional trick modes.

### BRIEF DESCRIPTION OF THE DRAWINGS

The same numbers are used throughout the drawings to reference like features.

FIG. 1 illustrates an example device implementing the trick mode based advertisement portion selection in accordance with one or more embodiments.

FIGS. 2, 3, 4, and 5 illustrate examples of the trick mode based advertisement portion selection discussed herein in accordance with one or more embodiments.

FIG. 6 is a flowchart illustrating an example process for playing back audio/video content with the trick mode based advertisement portion selection in accordance with one or more embodiments.

FIG. 7 is a flowchart illustrating an example process for generating advertisement trick mode data for the trick mode based advertisement portion selection in accordance with one or more embodiments.

FIG. 8 illustrates an example system in which one or more embodiments of the trick mode based advertisement portion selection can be implemented.

FIG. 9 illustrates various components of an example consumer device that can be implemented as any form of a computing, electronic, or television client device to implement one or more embodiments of the trick mode based advertisement portion selection.

FIG. 10 illustrates an example entertainment and information system in which one or more embodiments of the trick mode based advertisement portion selection can be implemented.

### DETAILED DESCRIPTION

Trick mode based advertisement portion selection is discussed herein. During playback of audio/video content, the audio/video content can be played back in a trick mode that skips sections of the content and/or has a trick play speed that is faster or slower than the normal playback speed of the content. This audio/video content includes both programming and advertising. During this trick mode playback, when an advertising segment of the audio/video content is encountered, ad trick mode data is accessed to determine one or more portions of an advertisement to be played back as well as the timing of the playback (e.g., controlling how long different portions are to be played). Playback of the programming in the trick mode ceases while the identified one or more portions of the advertisement are played back during the advertising segment, after which playback of the programming in the trick mode continues.

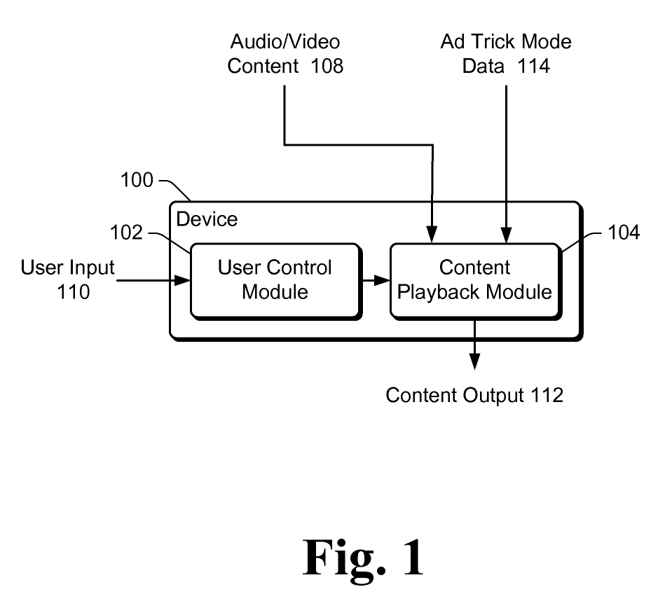

FIG. 1 illustrates an example device 100 implementing the trick mode based advertisement portion selection in accordance with one or more embodiments. Device 100 can be any of a variety of devices that output audio/video content for playback. For example, device 100 can be a computer, such as a desktop computer or a server computer, a handheld computer or personal digital assistant (PDA), a mobile station, an entertainment appliance, a set-top box communicatively coupled to a display device, a video playback device (e.g., digital video recorder (DVR), digital versatile disk (DVD) player, etc.), a television, a cell or other wireless phone, a game console, an automotive PC, and so forth. Thus, device 100 can range from full resource devices with substantial memory and processor resources (e.g., personal computers, game consoles, etc.) to low-resource devices with limited memory and/or processing resources (e.g., traditional set-top boxes, hand-held game consoles, DVD players, etc.).

Device 100 includes a user control module 102 and a content playback module 104. Content playback module 104 receives audio/video content 108. Audio/video content 108 can be any audio/video content that can be communicated to device 100. Examples of such audio/video content include video on demand (VOD) programs, previously recorded programs, live programs and/or channels, advertisements, and so forth. Audio/video content 108 can be a variety of different programs or shows, such as movies, sitcoms, commercials, news broadcasts, documentaries, sporting events, and so forth. Audio/video content 108 can be received in any of a variety of manners, such as via wired or wireless transmission media, from a disc (e.g., optical or magnetic) or other physical media, and so forth.

Audio/video content 108 includes programming content and advertising content. Programming content refers to programs or shows as discussed above. Advertising content refers to advertisements (ads) that are played back to the user, typically during advertising segments interspersed among programming segments during which the programming content is played back.

In one or more embodiments, the programming content and advertising content are received from the same source. For example, both the programming content and advertising content can be broadcast or otherwise communicated to device 100 via a particular television channel. Alternatively, the programming content and advertising content can be received from different sources. For example, advertising content can be obtained from a different channel or server, or can be previously downloaded and stored by device 100 for subsequent playback during an advertising segment.

Content playback module 104 also receives ad trick mode data 114. Each advertisement has associated with it ad trick mode data 114 identifying how to play back that particular advertisement during an advertising segment. This ad trick mode data 114 and its use are discussed in more detail below.

During operation, user control module 102 receives user input 110 to control playback of audio/video content 108. User input 110 can be received in a variety of different manners, such as via a remote control device, keys or buttons on device 100, verbal commands, and so forth. User input 110 can include, for example, requests to play back audio/video content at a normal playback speed (the normal speed at which the audio/video content is played back), requests to play back audio/video content in a trick mode, requests to pause playback of the audio/video content, and so forth.

The trick modes can take a variety of different forms, and each trick mode plays back the audio/video content in the forward or in the reverse direction. Each trick mode can also have a particular trick play speed or skip interval. Examples of forward direction trick modes include a fast-forward trick mode that plays back the audio/video content at a trick play speed that is faster than the normal playback speed, a slow motion trick mode that plays back the audio/video content at a trick play speed that is slower than the normal playback speed, and a skip forward trick mode that causes the audio/video content to jump or skip ahead to different sections of the audio/video content (e.g., these different sections can be defined in the audio/video content, can be at particular intervals such as every 30 seconds or every 5 minutes, etc.), and so forth. Examples of reverse direction trick modes include a rewind trick mode that plays back the audio/video content backwards at a trick play speed that is faster or slower than the normal playback speed (or a trick play speed that is the normal playback speed), and a skip back trick mode that causes the audio/video content to jump or skip backwards to different sections of the audio/video content (e.g., these different sections can be defined in the audio/video content, can be at particular intervals such as every 30 seconds or every 5 minutes, etc.), and so forth.

Content playback module 104 receives indications of user input 110 from user control module 102, and plays back audio/video content 108 as content output 112 in accordance with the user input 110. During advertising segments, one or more portions of the advertising content are played back by module 104. The advertisement playback is modified based on the current trick mode and advertising trick mode data 114, as discussed in more detail below.

In one or more embodiments, device 100 plays back content output 112 (e.g., displays video content, plays back audio content, and so forth). In other embodiments device 100 generates one or more signals based on audio/video content 108 that are output to one or more other devices (e.g., televisions, projectors, speakers, etc.) which in turn display or otherwise present content output 112.

Playback of advertisements in the audio/video content 108 is determined based on the trick mode and ad trick mode data 114 as discussed in more detail below. Playback of programming content in the audio/video content 108 in a trick mode can be performed using any of a variety of conventional trick mode techniques. For example, one or more frames in audio/video content 108 can be skipped during a fast forward or fast rewind trick mode, with the number of frames that are skipped being dependent on the trick play speed for the trick mode. By way of another example, frames in audio/video content 108 can be displayed for longer than their normal duration for a slow motion trick mode, with the length of their display being dependent on the trick play speed for the trick mode. Regardless of the technique used to play back the programming content in the trick mode, use of that technique ceases during an advertising segment, and ad trick mode data 114 is used instead as discussed in more detail below.

Ad trick mode data 114 identifies, for a given ad, how to play back that ad during an advertising segment. The playback of the ad can be modified in different manners based on the current trick mode being used for playback of the programming content. This current trick mode also has a trick play speed, and different trick modes can have different trick play speeds. For example, one trick mode may be fast-forward at five times the normal playback rate, while another trick mode may be fast-forward at ten times the normal playback rate. Content playback module 104 knows the current trick mode for the programming content, and accesses ad trick mode data 114 to identify how to play back the ad given that trick mode.

Ad trick mode data 114 identifies one or more portions of an ad to be played back for a given trick mode. For trick modes with trick play speeds that are faster than the normal playback speed, or skip forward trick modes, these one or more portions are typically less than the entire advertisement. In one or more embodiments each of these one or more portions is a frame of video data (and optionally corresponding audio or other data). The one or more portions can thus include one or more frames. In such embodiments, ad trick mode data 114 identifies a particular frame or frames based on a playback time, offset value, or other frame identifier. Alternatively, each of the one or more portions can be identified in different manners, such as by a time range identifying a temporal range of the ad to be played back, by an identifier of a previously defined section of the ad, using an algorithm or other function to be applied to the ad to determine the portion, and so forth.

Additionally, ad trick mode data 114 can optionally include a time identifier for a frame that indicates a duration (e.g., in milliseconds, seconds, etc.) that is how long the frame is to be played back. When the ad is played back, the frame is played back for the duration specified by the time identifier. Accordingly, playback of an ad for a particular trick mode can be repeated display of the same single frame of the ad. For example, playback of an ad for a particular trick mode could be the display of a single frame containing a logo and phone number of the advertiser for the specified duration. Alternatively, the time identifier can be associated with a portion rather than a frame, so that playback of the portion (which can include multiple frames) is repeated during playback of the ad. Alternatively, a frame can have a corresponding identifier that indicates a duration for playback of a frame in some manner other than time, such as by using a repetition count that indicates how many times playback of the frame is to be repeated during playback of the ad.

By way of example, ad trick mode data 114 can include a record for each of multiple trick modes supported by device 100, such as one record for a rewind at two times the normal playback speed trick mode, another record for a fast-forward at two times the normal playback speed trick mode, and yet another record for a fast-forward at ten times the normal playback speed trick mode. Each record identifies one or more portions of the ad to be played back when programming on device 100 is being played back using that particular trick mode. The one or more portions are played back by module 104 at the normal playback speed, not in the trick mode. For example, even if the trick play speed of the trick mode is five times the normal playback speed (also referred to as 5×) or the trick mode is a skip forward trick mode, the one or more portions of the ad are played back at the normal playback speed (also referred to as 1×). As the one or more portions of the ad are typically determined with knowledge of the trick mode, the number of portions identified in the ad are typically reduced so whatever trick mode technique is used for playback of the programming content need not be used for playback of the ad. For example, if the trick play speed were 5×, the one or more portions would typically be approximately one-fifth of the number of portions in the entire ad.

In one or more embodiments, records identifying trick play speeds can be maintained and the forward or reverse direction of the trick mode (and/or other characteristics of the trick mode) is inherent. For example, the trick mode based advertisement portion selection may be implemented for fast-forward trick modes but not other trick modes. In such implementations, the trick play speed is used to identify the particular one or more portions to be played back, and additional information identifying direction, regarding skipping forward or back, or slow motion, need not be used.

It should also be noted that the order of playback of the portions of the ad can be inherent in the data 114. For example, the order of playback of the portions can be the same order as the portions exist in the ad (e.g., based on timestamps or offsets of frames of the portions). Alternatively, ad trick mode data 114 can identify a particular order of playback for the portions. By way of another example, the order of playback of the portions can be the order in which the portions are identified in the ad trick mode data. This allows the ad trick mode data 114 to define the order of portions for the ad, and optionally change an order of the portions to be other than the order of the portions as the portions exist in the ad (or to have the portions be a single frame).

It should further be noted that the size of the advertising segment typically changes with the trick play speed or skip interval of the trick mode. The advertising segment size changes proportionally to the trick play speed or skip interval, so that the advertising segment increases in size as the trick play speed or skip interval decreases, and decreases in size as the trick play speed or skip interval increases. This keeps the proportion of advertising segment size to programming segment size approximately the same regardless of the playback speed or skip interval. Typically, the size of the advertising segment is determined by the formula 1÷y, where y represents the trick play speed or skip interval. For example, assume that an advertising segment were to be 60 seconds in duration during a normal playback speed of audio/video content 108. If the trick play speed were to be 2×, then the advertising segment would be 30 seconds (one-half of 60 seconds). If the trick play speed were to be 10×, then the advertising segment would be 6 seconds (one-tenth of 60 seconds). If the trick play speed were to be 0.5×, then the advertising segment would be 120 seconds (2 times 60 seconds). If the skip interval were to be two minutes, then the advertising segment would be 0.5 seconds (1÷120=0.00833 of 60 seconds).

Ad trick mode data 114 is typically created by the advertiser or other provider of the ad. This allows the advertiser or other provider of the ad to identify which portions are desired given particular trick modes. For example, the advertiser can select one or more portions of an ad for playback at a fast-forward trick play speed of 2×, one or more other portions of the ad for playback at a fast-forward trick play speed of 10×, and still one or more other portions if the user is skipping forward through sections of audio/video content 108. Alternatively, ad trick mode data 114 can be created by other entities or components and provided to device 100.

The locations of the advertising segments in audio/video content 108 (e.g., beginnings and endings of the advertising segments) can be identified in a variety of different manners. In one or more embodiments, audio/video content 108 includes identifiers or signals of where the advertising segments are. These identifiers can include an advertising segment beginning identifier and ending identifier, an advertising segment beginning identifier and an advertising segment duration identifier, an advertising segment beginning identifier and a corresponding inherent or previously defined advertising segment duration, and so forth. For example, these identifiers can be in a header of programming content, can be dispersed in content 108 at regular or irregular intervals, can be included in content 108 a particular amount of time before an advertising segment occurs, and so forth. In other embodiments, the advertising segments are identified in other manners. For example, content playback module 104 can determine when the advertising segments occur based on a particular set of rules or an algorithm, content playback module 104 can receive a signal from another component or module of device 100 or of another device indicating when the advertising segments occur, and so forth.

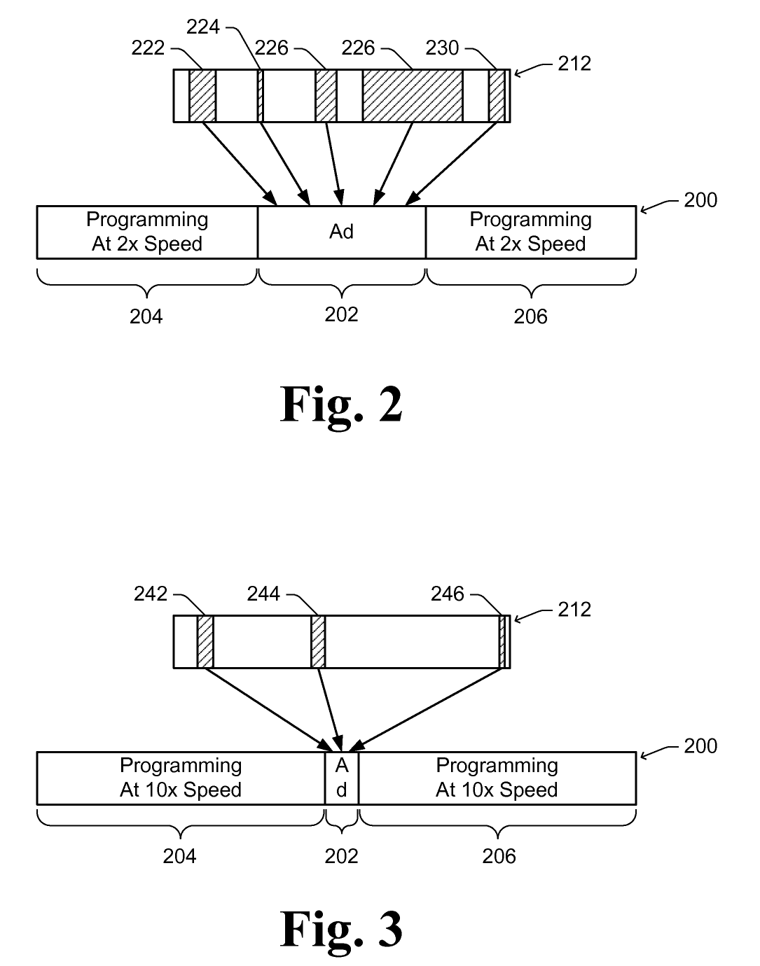

FIGS. 2, 3, 4, and 5 illustrate examples of the trick mode based advertisement portion selection discussed herein in accordance with one or more embodiments. Each of FIGS. 2, 3, 4, and 5 illustrates audio/video content 200 being played back in a fast-forward or reverse direction. The audio/video content 200 includes an advertising segment 202 during which one or more portions of an advertisement 212 are played back, and two programming segments 204 and 206 during which programming is played back. Trick modes having different trick play speeds are assumed in the examples of FIGS. 2, 3, 4, and 5 resulting in different portions of the advertisement 212 being played back. For ease of explanation, FIGS. 2, 3, 4, and 5 are discussed with reference to a single advertisement 212 being played back in advertising segment 202. It is to be appreciated, however, that multiple advertisements can be displayed during an advertising segment 202, and each of these multiple advertisements can have associated trick mode data identifying portions of that advertisement to play back for different trick play speeds.

In FIG. 2, the programming of audio/video content 200 is played back with a trick play speed of twice the normal playback speed, also referred to as 2×. Programming content is played back in programming segment 204 at a trick play speed of 2× using any of a variety of trick mode techniques as discussed above. At the beginning of advertising segment 202, playback of audio/video content 200 using the trick mode technique used for programming segment 204 ceases and the ad trick mode data is used to determine one or more portions of ad 212 to play back during advertising segment 202.

The example of FIG. 2 assumes that ad trick mode data associated with ad 212 identifies portions 222, 224, 226, 228, and 230 as the portions to be played back during advertising segment 202 when the trick play speed of the audio/video content 200 is 2×. Accordingly, portions 222, 224, 226, 228, and 230 are played back during segment 202. At the end of advertising segment 202, playback of the programming content resumes at the trick play speed of 2× using any of a variety of trick mode techniques as discussed above.

In FIG. 3, the programming of audio/video content 200 is played back with a trick play speed of ten times the normal playback speed, also referred to as 10×. Programming content is played back in programming segment 204 at a trick play speed of 10× using any of a variety of trick mode techniques as discussed above. At the beginning of advertising segment 202, playback of audio/video content 200 using the trick mode technique used for programming segment 204 ceases and the ad trick mode data is used to determine one or more portions of ad 212 to play back during advertising segment 202.

The example of FIG. 3 assumes that ad trick mode data associated with ad 212 identifies portions 242, 244, and 246 as the portions to be played back during advertising segment 202 when the trick play speed of the audio/video content 200 is 10×. Accordingly, portions 242, 244, and 246 are played back during segment 202. At the end of advertising segment 202, playback of the programming content resumes at the trick play speed of 10× using any of a variety of trick mode techniques as discussed above.

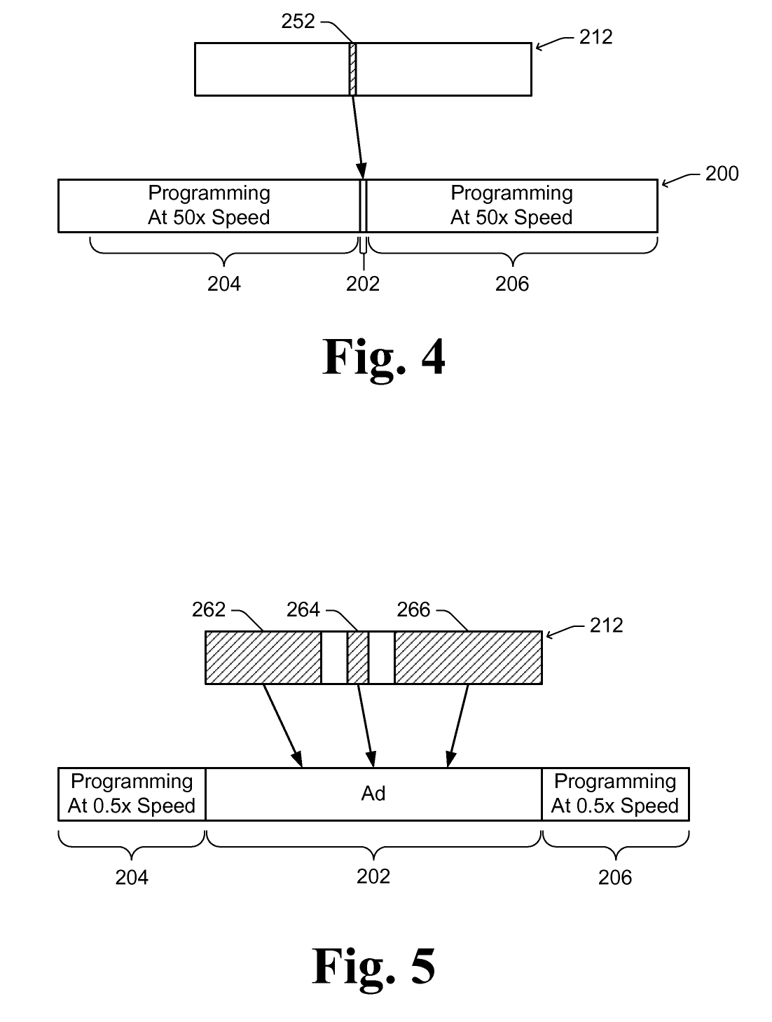

In FIG. 4, the programming of audio/video content 200 is played back with a trick play speed of fifty times the normal playback speed, also referred to as 50×. Programming content is played back in programming segment 204 at a trick play speed of 50× using any of a variety of trick mode techniques as discussed above. At the beginning of advertising segment 202, playback of audio/video content 200 using the trick mode technique used for programming segment 204 ceases and the ad trick mode data is used to determine one or more portions of ad 212 to play back during advertising segment 202.

The example of FIG. 4 assumes that ad trick mode data associated with ad 212 identifies portion 252 as the portion to be played back during advertising segment 202 when the trick play speed of the audio/video content 200 is 50×. Accordingly, portion 252 is played back during segment 202. At the end of advertising segment 202, playback of the programming content resumes at the trick play speed of 50× using any of a variety of trick mode techniques as discussed above.

In FIG. 5, the programming of audio/video content 200 is played back with a trick play speed of one-half the normal playback speed, also referred to as 0.5×. Programming content is played back in programming segment 204 at a trick play speed of 0.5× using any of a variety of trick mode techniques as discussed above. At the beginning of advertising segment 202, playback of audio/video content 200 using the trick mode technique used for programming segment 204 ceases and the ad trick mode data is used to determine one or more portions of ad 212 to play back during advertising segment 202.

The example of FIG. 3 assumes that ad trick mode data associated with ad 212 identifies portions 262, 264, and 266 as the portions to be played back during advertising segment 202 when the trick play speed of the audio/video content 200 is 0.5×. Accordingly, portions 262, 264, and 266 are played back during segment 202. As the length of advertising segment 202 is longer due to the 0.5× trick play speed, one or more of the frames in portions 262, 264, and 266 can have time identifiers to indicate that the one or more frames are to be displayed multiple times. At the end of advertising segment 202, playback of the programming content resumes at the trick play speed of 0.5× using any of a variety of trick mode techniques as discussed above.

Thus, as can be seen in the examples of FIGS. 2, 3, 4, and 5 playback of programming content in a trick mode ceases when an advertising segment is encountered. During the advertising segment, rather than using the same trick mode technique as is used for determining what portions of programming content to play back, the ad trick mode data associated with the ad is used to identify one or more portions of the ad to be played back. At the end of the advertising segment, playback of the programming content in the trick mode resumes.

Returning to FIG. 1, ad trick mode data 114 can be obtained by content playback module 104 in a variety of different manners. In one or more embodiments, ad trick mode data 114 is a set of records that are delivered to or otherwise retrieved by module 104. This set of records can be obtained and stored, for example, as a table of records. In other embodiments, ad trick mode data 114 is obtained in different manners. For example, ad trick mode data 114 can be embedded in audio/video content 108, can be included in a header or other portion of an advertisement, can be included as metadata associated with frames of the advertisement content (e.g., metadata indicating whether the frame is to be played back for particular trick modes), and so forth. As a specific example, a linked list can be embedded in metadata associated with frames of the advertisement content, with the metadata for each frame indicated what the next frame to play back is. Different linked lists can be maintained in the metadata for different trick modes. It is to be appreciated that ad trick mode data 114 can be received embedded in audio/video content 108, or alternatively separately from audio/video content 108.

The discussions herein discuss the playback of portions of an ad based on the trick mode. It should be noted that this playback can include the display of video data, the audible playback of audio data, as well as the presentation of other data (e.g., text data, images, and so forth). In one or more embodiments, the audio and other data that is played back is based on the frames that are displayed. For example, the audio data corresponding to the frames that are displayed during an advertising segment is played back during the advertising segment.

In other embodiments, ad trick mode data 114 identifies, for each different type of data, what data is to be played back for a given trick mode. For example, for a particular trick mode one set of portions of the ad to be displayed can be identified, and a second set of portions of the ad to be audibly played back can be identified. In such embodiments, the audio data that is played back need not be the audio data associated with the particular frames of the ad being displayed. The playback of this audio data or other data can also be changed, such as by including time identifiers for parts of the data analogous to the time identifiers for frames discussed above, adjusting audio playback to make it more legible (e.g., in the case of a slow motion trick mode), and so forth.

It is to be appreciated that in one or more embodiments, one or more frames may rely on data from one or more other frames in order to be displayed properly. In such embodiments, ad trick mode data 114 is typically prepared to account for such frames. Data 114 can account for such frames in different manners, such as including in the one or more portions for a particular trick mode the other frames relied on to display a particular frame, selecting only frames that do not rely on other frames for proper display, and so forth.

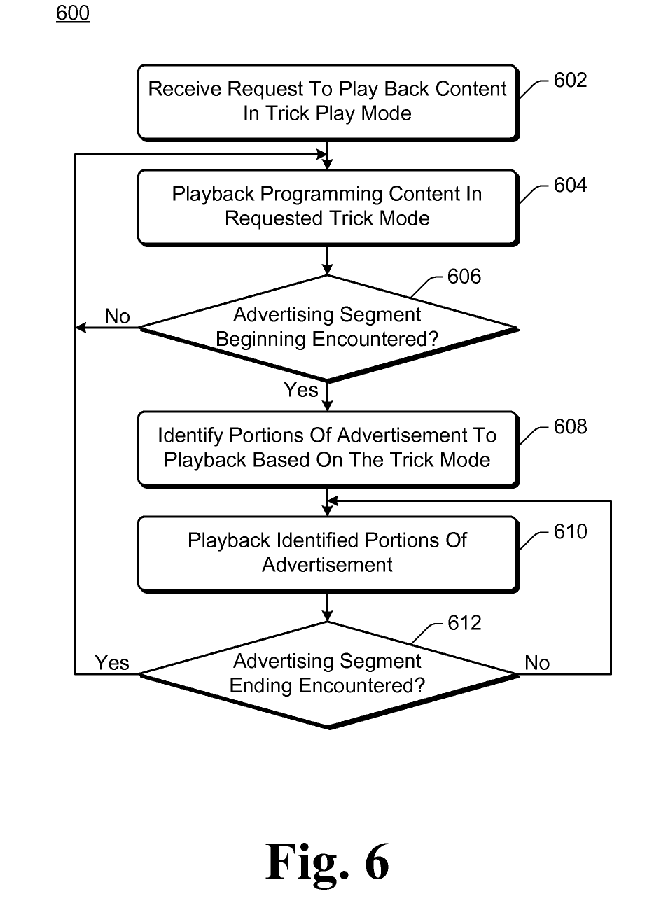

FIG. 6 is a flowchart illustrating an example process 600 for playing back audio/video content with the trick mode based advertisement portion selection in accordance with one or more embodiments. Process 600 is carried out by a device, such as device 100 of FIG. 1, and can be implemented in software, firmware, hardware, or combinations thereof. Process 600 is an example process for playing back audio/video content with the trick mode based advertisement portion selection; additional discussions of playing back audio/video content with the trick mode based advertisement portion selection are included herein with reference to different figures.

In process 600, a request to play back audio/video content in a trick play mode is received (act 602). This request can be a user request as discussed above, or alternatively can be a request from another component or module.

The programming content is played back in the requested trick mode (act 604). As discussed above, this playback can be performed using a variety of different conventional techniques.

Playback of the programming content in the requested trick mode continues until a beginning of an advertising segment is encountered (act 606). The locations of advertising segments in the audio/video content can be identified in different manners, as discussed above.

One or more portions of the advertisement are identified to play back based on the trick mode (act 608). This trick mode is the trick mode used for playing back the programming content in act 604. These one or more identified portions of the advertisement are played back during the advertising segment (act 610). These one or more identified portions are also optionally played back in a different order than they appear in the ad, as discussed above.

When the ending of the advertising segment is encountered (act 612), playback of the programming in the requested trick mode resumes (act 604). The ending of the advertising segment can be identified in different manners, as discussed above.

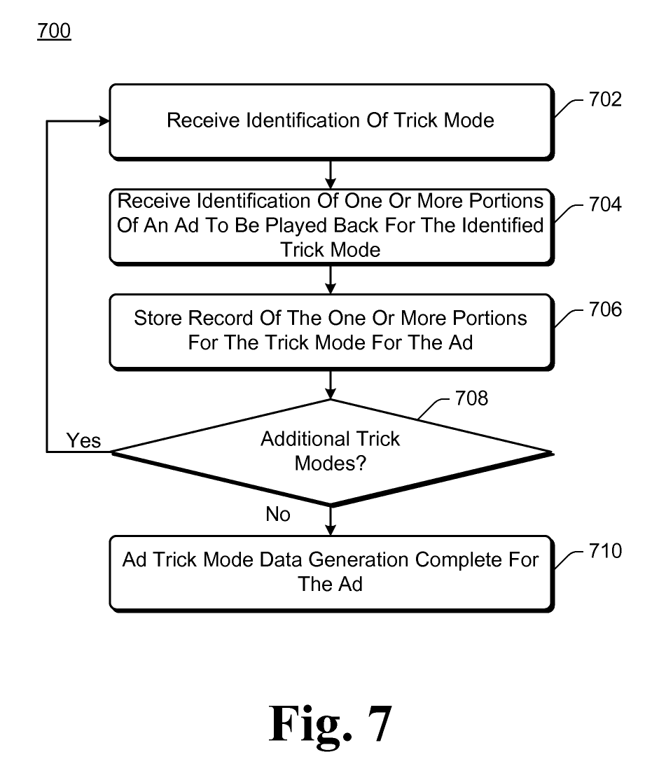

FIG. 7 is a flowchart illustrating an example process 700 for generating advertisement trick mode data for the trick mode based advertisement portion selection in accordance with one or more embodiments. Process 700 is carried out by any of a variety of different computing devices, such as a desktop computer, a server computer, a laptop computer, and so forth. Process 700 can be implemented in software, firmware, hardware, or combinations thereof. Process 700 is an example process for generating ad trick mode data for the trick mode based advertisement portion selection; additional discussions of generating ad trick mode data for the trick mode based advertisement portion selection are included herein with reference to different figures.

In process 700, an identification of a trick mode is received (act 702). An identification of one or more portions of an advertisement to be played back for the identified trick mode is also received (act 704). Additionally, an indication of a duration for playback of a particular one or more frames in the one or more portions can also optionally be received in act 704.

A record of the trick mode and the one or more portions of the advertisement to be played back for the trick mode is stored (act 706). This record can also optionally include a time identifier for one or more frames that identifies a duration for playback of the one or more frames. This record can be stored in different locations as discussed above, such as in the advertisement, in a table associated with the advertisement, and so forth.

A check is then made as to whether there are additional trick modes for which one or more portions are to be identified (act 708). This check can be performed, for example, based on input received from a user of the device implementing process 700 indicating whether there are additional trick modes for which one or more portions are to be identified. If there are additional trick modes for which one or more portions are to be identified, then process 700 returns to act 702 to receive an identification of one of such trick modes. However, if there are no additional trick modes for which one or more portions are to be identified, then the ad trick mode data generation for the advertisement is complete (act 710).

The trick mode based advertisement portion selection discussed herein allows for various usage scenarios. By way of example, an advertiser may decide that if the trick mode selected by the user is fast-forward at 5×, then a particular portion in the middle of the advertisement is to be played. This particular portion can be associated with the trick mode of fast-forward at 5× for the advertisement so that that particular portion is played back when the user has selected a fast-forward at 5× trick mode. By way of another example, the advertiser may further decide that if the trick mode selected by the user is fast-forward at 100×, then a particular frame (such as a frame displaying a product or service logo and a phone number or web site) is to be displayed repeatedly for the advertisement. This particular frame is thus displayed repeatedly as the advertisement if the user has selected a fast-forward at 100× trick mode, rather than displaying multiple portions of the advertisement.

It should also be noted that various revenue models can be tied to the trick mode based advertisement portion selection. For example, advertisers can pay an additional fee in order to have ad trick mode data associated with their ads. If the additional fee is not paid, then no ad trick mode data is associated with the ad and the ad is played back using the same trick mode technique as is used to play back the programming content. By way of another example, advertisers can pay an additional fee in order to have a certain number of portions associated with a trick mode, such as to have a single frame associated with a particular trick mode.

In the discussions above, the size of the advertising segment is described as changing based on the trick play speed or skip interval of the trick mode (e.g., getting shorter for faster trick play speeds or longer skip intervals). Alternatively, the size of the advertising segment does not change based on the trick play speed or skip interval. Rather, the ad trick mode data 114 can indicate that all portions of the ad are to be played back. Thus, even though the trick mode for the audio/video content 108 may be fast-forward at 10×, the ad is still played back at the normal playback rate (1×). Various revenue models can also be tied to this ability to specify that the normal playback rate is to be used. For example, advertisers can pay an additional fee in order to have all portions of their ad identified as to be played back regardless of the trick mode for the audio/video content 108.

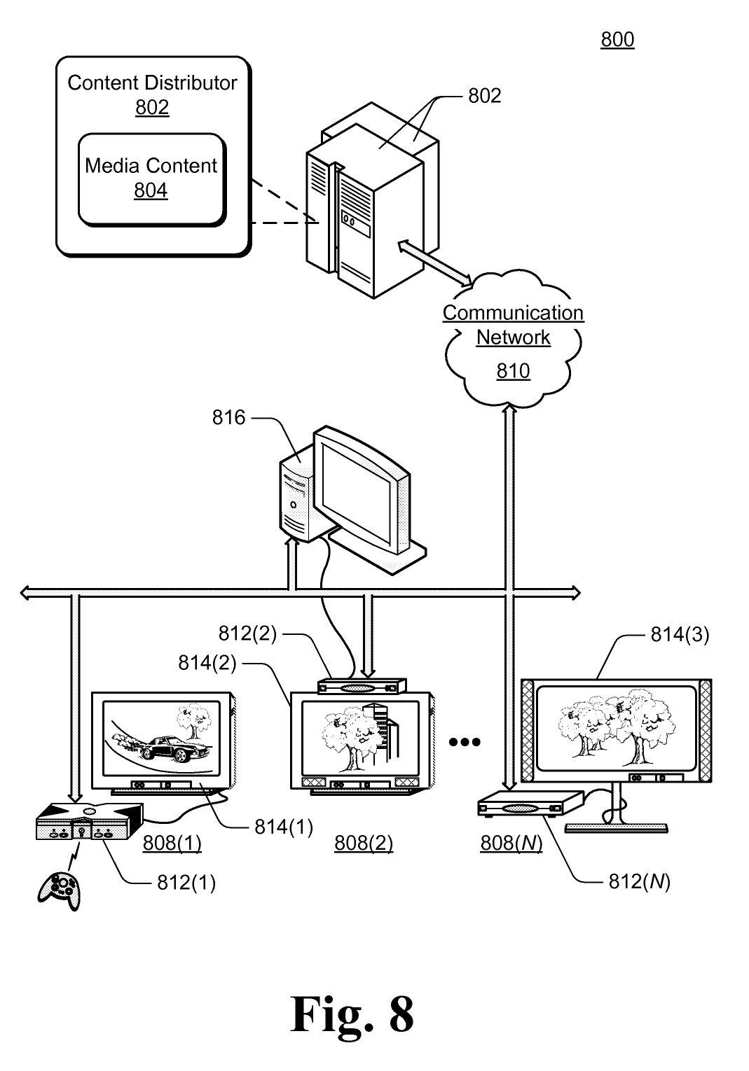

FIG. 8 illustrates an example system 800 in which one or more embodiments of the trick mode based advertisement portion selection can be implemented. System 800 includes one or more content distributors 802 that communicate media content 804 (such as audio/video content 108 of FIG. 1) to any number “N” of various television client systems 808(1-N) via a communication network 810. Client systems 808 can each be, for example, a different type (or alternatively the same types) of device 100 of FIG. 1. Communication network 810 can be implemented to include an Internet Protocol (IP) based network that facilitates media content distribution and data communication between the content distributor(s) 802 and any number of television client devices.

Each of client systems 808(1-N) includes a respective television client device 812(1-N) and a respective display device 814(1-N), such as any type of television, monitor, LCD, projector, or similar television-based display system that renders audio, video, and/or image data. Any of client devices 812(1-N) can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device. Any of television client devices 812(1-N) may also be associated with a user (e.g., a person) and/or an entity that operates a client device such that a television client device describes logical clients that include users, software, and/or devices. In this example of FIG. 8, client device 812(2) is a television set-top box that is connected, or otherwise communicatively linked, to a computing device 816.

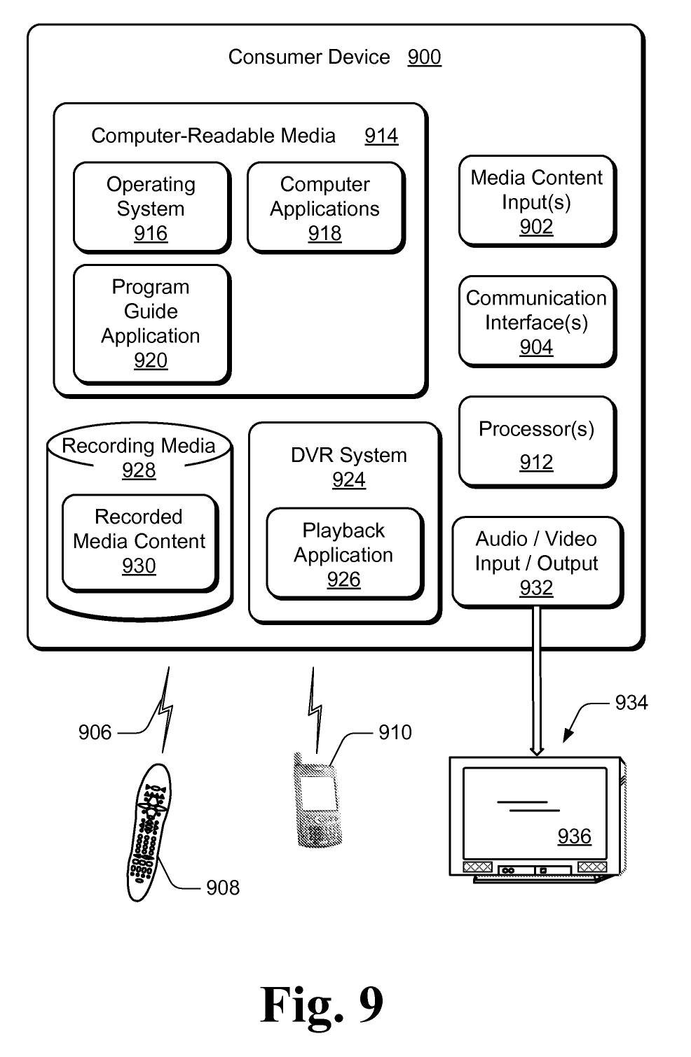

Any of television client devices 812(1-N) of the respective client systems 808(1-N) can be implemented with one or more processors, a communication module, memory components, a media content rendering system, and a content retrieval module. Additionally, each of television client devices 812(1-N) can be configured for communication with any number of different content distributors 802 to receive any type of media content 804 via the communication network 810. Further, any of the television client devices 812(1-N) can be implemented with any number and combination of differing components as further described with reference to the example client device shown in FIG. 9.

FIG. 9 illustrates various components of an example consumer device 900 that can be implemented as any form of a computing, electronic, or television client device to implement one or more embodiments of the trick mode based advertisement portion selection. For example, consumer device 900 can be implemented as a device 100 shown in FIG. 1, and/or as any of the client devices 812(1-N) of client systems 808(1-N) shown in FIG. 8. In various embodiments, consumer device 900 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Consumer device 900 includes one or more media content inputs 902 that may include IP inputs over which streams of media content are received via an IP-based network. Consumer device 900 further includes communication interface(s) 904 that can be implemented as any one or more of a serial and/or parallel interface, a wireless interface, any type of network interface, a modem, and as any other type of communication interface. A wireless interface enables client device 900 to receive control input commands 906 and other information from an input device, such as from remote control device 908, a portable computing-based device (such as a cellular or other wireless phone) 910, or from another infrared (IR), 802.11, Bluetooth, or similar RF input device.

A network interface provides a connection between consumer device 900 and a communication network by which other electronic and computing devices can communicate data with device 900. Similarly, a serial and/or parallel interface provides for data communication directly between client device 900 and the other electronic or computing devices. A modem facilitates client device 900 communication with other electronic and computing devices via a conventional telephone line, a DSL connection, cable, and/or other type of connection.

Consumer device 900 also includes one or more processors 912 (e.g., any of microprocessors, controllers, and the like) which process various computer-executable instructions to control the operation of device 900, to communicate with other electronic and computing devices, and to implement embodiments of the trick mode based advertisement portion selection. Consumer device 900 can be implemented with computer-readable media 914, such as one or more memory components, examples of which include random access memory (RAM), nonvolatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD) or DVD, and the like.

Computer-readable media 914 provides data storage mechanisms to store various information and/or data such as software applications and any other types of information and data related to operational aspects of consumer device 900. For example, an operating system 916 and/or other computer applications 918 can be maintained as software applications with the computer-readable media 914 and executed on processor(s) 912 to implement embodiments of the trick mode based advertisement portion selection.

Consumer device 900 can also include a program guide application 920 that is implemented to process program guide data and generate program guides for display. A program guide enables a viewer to navigate through an onscreen display and locate various media content such as broadcast programs, recorded programs, video on demand programs and movies, interactive game selections, network-based applications, and other media content of interest to the viewer. Other modules, such as a content retrieval module, can also be included in consumer device 900, or alternatively incorporated into other components or modules of consumer device 900.

Consumer device 900 can also include a DVR system 924 with playback application 926, and recording media 928 to maintain recorded media content 930 that consumer device 900 receives and/or records. Further, consumer device 900 may access or receive additional recorded media content that is maintained with a remote data store (not shown). Consumer device 900 may also receive media content from a video on demand server, or media content that is maintained at a broadcast center or content distributor that distributes the media content to subscriber sites and client devices. Playback application 926 is a video control application that can be implemented to control the playback of media content, the recorded media content 930, and/or other video on demand media content, music, and any other audio, video, and/or image media content which can be rendered and/or displayed for viewing. Playback application 926 can optionally implement content playback module 104, or alternatively module 104 can be implemented by another component or module (such as audio/video input/output 932).

Consumer device 900 also includes an audio and/or video output 932 that provides audio and/or video data to an audio rendering and/or display system 934. Audio rendering and/or display system 934 can include any devices that process, display, and/or otherwise render audio, video, and image data. Video signals and audio signals can be communicated from consumer device 900 to a display device 936 via an RF (radio frequency) link, S-video link, composite video link, component video link, DVI (digital video interface), analog audio connection, or other similar communication link. Alternatively, audio rendering and/or display system 934 can be implemented as integrated components of the example consumer device 900. Consumer device 900 along with the audio rendering and/or display system 934 is an example of a viewing system that can be implemented in a household viewing area for viewing television programs and/or receiving other television media content.

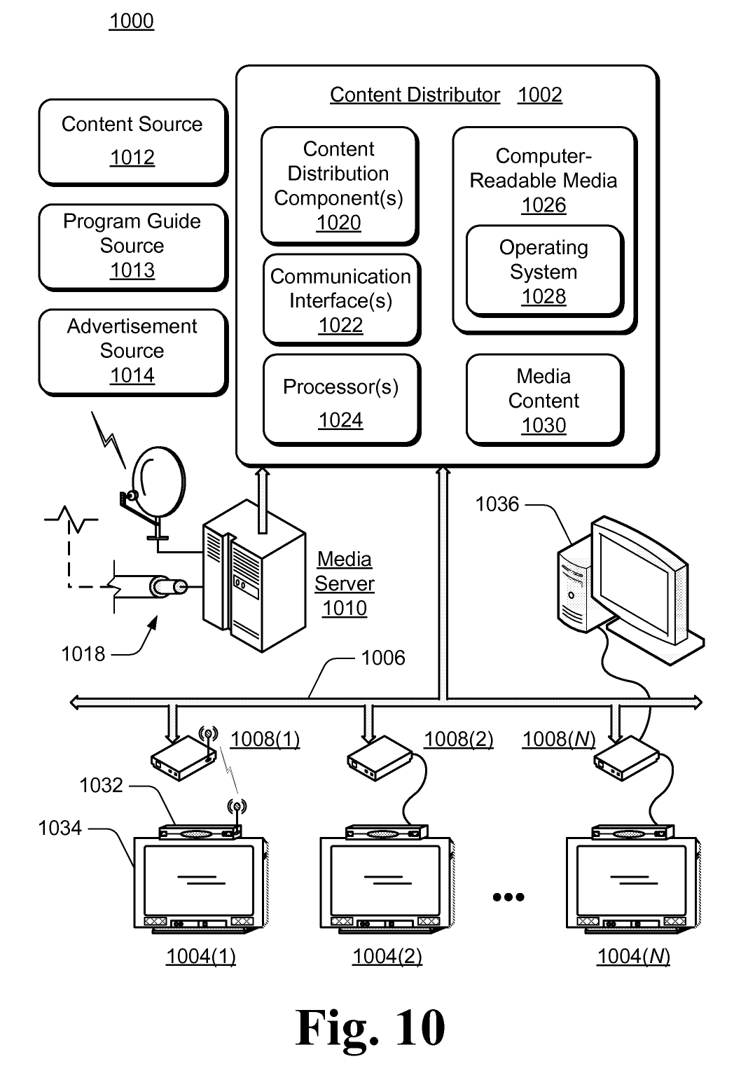

FIG. 10 illustrates an example entertainment and information system 1000 in which one or more embodiments of the trick mode based advertisement portion selection can be implemented. System 1000 facilitates the distribution of media content, program guide data, and advertising content to multiple viewers and to multiple viewing systems. System 1000 includes a content distributor 1002 and any number “N” of client systems 1004(1-N) each configured for communication via a communication network 1006. Each client system 1004(1-N) is an example of the client systems 808(1-N) described with reference to FIG. 8. Each of the client systems 1004(1-N) can receive data streams of media content, media content, program guide data, advertising content, closed captioning data, other content, and the like from content server(s) of content distributor 1002 via communication network 1006.

Communication network 1006 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 1006 can be implemented using any type of network topology and any network communication protocol, and can be represented or otherwise implemented as a combination of two or more networks. A digital network can include various hardwired and/or wireless links 1008(1-N), routers, gateways, and so on to facilitate communication between content distributor 1002 and client systems 1004(1-N).

System 1000 includes a media server 1010 that receives programming content from a content source 1012, program guide data from a program guide source 1013, and advertising content from an advertisement source 1014. In one or more embodiments, media server 1010 represents an acquisition server that receives the audio and video media content from content source 1012, an EPG server that receives the program guide data from program guide source 1013, and/or an advertising management server that receives the advertising content from the advertisement source 1014.

Content source 1012, program guide source 1013, and advertisement source 1014 control distribution of the media content, the program guide data, and at least some of the advertising content to the media server 1010 and/or to other servers. The media content, program guide data, and advertising content can be distributed via various transmission media 1018, such as satellite transmission, radio frequency transmission, cable transmission, and/or via any number of other wired or wireless transmission media. In this example, media server 1010 is shown as an independent component of system 1000 that communicates the media content, program guide data, advertising content, and content descriptions to content distributor 1002. In an alternate implementation, media server 1010 can be implemented as a component of content distributor 1002.

Content distributor 1002 is representative of a headend service in a content distribution system, for example, that provides the media content, program guide data, advertising content, and content descriptions to multiple subscribers (e.g., the client systems 1004(1-N)). Content distributor 1002 can be implemented as a satellite operator, a network television operator, a cable operator, and the like to control distribution of media content, program and advertising content, and content descriptions, such as movies, television programs, commercials, music, and other audio, video, and/or image content to client systems 1004(1-N).

Content distributor 1002 includes various content distribution components 1020 to facilitate media content processing and distribution, such as a subscriber manager, a device monitor, and one or more content servers. The subscriber manager manages subscriber data, and the device monitor monitors client systems 1004(1-N) (e.g., and the subscribers), and maintains monitored client state information.

Although the various managers, servers, and monitors of content distributor 1002 (to include media server 1010 in one or more embodiments) are described as distributed, independent components of content distributor 1002, any one or more of the managers, servers, and monitors can be implemented together as a multi-functional component of content distributor 1002. Additionally, any one or more of the managers, servers, and monitors described with reference to system 1000 can implement features and embodiments of the trick mode based advertisement portion selection.

Content distributor 1002 includes communication interface(s) 1022 that can be implemented as any type of interface to communicate and receive data from client devices of the television system. Content distributor 1002 also includes one or more processors 1024 (e.g., any of microprocessors, controllers, and the like) which process various computer-executable instructions to control the operation of content distributor 1002. Content distributor 1002 can be implemented with computer-readable media 1026 which provides data storage to maintain software applications such as an operating system 1028 and media content 1030 for distribution to the client systems 1004(1-N).

Client systems 1004(1-N) can each be implemented to include a client device 1032 and a display device 1034 (e.g., a television, LCD, and the like). A client device 1032 of a respective client system 1004 can be implemented in any number of embodiments, such as a set-top box, a digital video recorder (DVR) and playback system, an appliance device, a gaming system, and as any other type of client device that may be implemented in an entertainment and information system. In an alternate embodiment, client system 1004(N) is implemented with a computing device 1036 as well as a client device. The computing device 1036 is an example of a connected data store that can record and maintain media content for a client device. Additionally, any client device 1032 of a respective client system 1004 can implement features and embodiments of the trick mode based advertisement portion selection as described herein.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer-readable memory devices. The features of the trick mode based advertisement portion selection described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
playing back programming content in a trick mode;
identifying, based at least in part on the trick mode, one or more portions of an advertisement to be played back, the one or more portions being less than the entire advertisement;
playing back the one or more portions of the advertisement during an advertising segment; and
resuming playing back the programming content in the trick mode after the advertising segment ends.

2. A method as recited in claim 1, further comprising:
playing back the programming content in a different trick mode;
identifying, based at least in part on the different trick mode, one or more additional portions of the advertisement to be played back, the one or more additional portions being less than the entire advertisement and being different than the one or more portions;
playing back the one or more additional portions during the advertising segment; and
resuming playing back the programming content in the different trick mode after the advertising segment ends.

3. A method as recited in claim 1, wherein the one or more portions comprises a single frame of the advertisement.

4. A method as recited in claim 3, wherein the identifying includes identifying a duration for which the single frame is to be played back, and wherein the playing back the one or more portions comprises playing back the single frame for the duration.

5. A method as recited in claim 1, wherein identifying the one or more portions comprises accessing a record associated with the advertisement, the record identifying the one or more portions to be played back for the trick mode.

6. A method as recited in claim 5, wherein the record is included in a header of the advertisement.

7. A method as recited in claim 5, wherein the record is included in a table associated with the advertisement.

8. A method as recited in claim 7, wherein the table includes multiple additional records each identifying one or more additional portions to be played back for a different trick mode.

9. A method as recited in claim 1, wherein playing back the one or more portions of the advertisement comprises playing back the one or more portions of the advertisement in an order other than an order in which the one or more portions exist in the advertisement.

10. A method as recited in claim 1, the identifying comprising identifying the one or more portions of the advertisement based at least in part on a trick play speed of the trick mode.

11. A method as recited in claim 1, wherein the method is implemented in a television set-top box.

12. A method comprising:
receiving an identification of a trick mode;
receiving an identification of one or more portions of an advertisement to be played back for the trick mode;
storing a record of the one or more portions for the trick mode for the advertisement; and
repeating receiving an identification of a trick mode, receiving an identification of one or more portions, and storing a record for one or more additional trick modes.

13. A method as recited in claim 12, the storing comprising storing the record as part of a linked list associated with the advertisement.

14. A method as recited in claim 12, the storing comprising including the record in the advertisement.

15. A method as recited in claim 12, the one or more portions comprising a single frame of the advertisement.

16. A method as recited in claim 15, further comprising:
receiving an indication of a duration for playback of the single frame during an advertising segment; and
storing in the record, as a time identifier, the duration for playback of the single frame during the advertising segment.

17. A method as recited in claim 12, the storing comprising storing the identification so that the one or more portions are played back in an order other than an order in which the one or more portions exist in the advertisement.

18. A method as recited in claim 12, wherein the identification of one or more portions of the advertisement is an identification of one or more portions of the advertisement to be played back for a trick play speed of the trick mode, and wherein the storing comprises storing a record of the one or more portions for the trick play speed of the trick mode for the advertisement.

19. One or more computer-readable media having stored thereon multiple instructions that, when executed by one or more processors of a device, cause the one or more processors to:
play back programming content in a first trick mode;
identify, based at least in part on the first trick mode, a first one or more portions of an advertisement to be played back, the first one or more portions being less than the entire advertisement;
play back the first one or more portions of the advertisement during an advertising segment;
resume play back of the programming content in the first trick mode after the advertising segment ends;
play back the programming content a second time in a second trick mode;
identify, based at least in part on the second trick mode, a second one or more portions of the advertisement to be played back, the second one or more portions being less than the entire advertisement and being different than the first one or more portions;
play back the second one or more portions of the advertisement during the advertising segment; and
resume play back of the programming content in the second trick mode after the advertising segment ends.

20. One or more computer-readable media as recited in claim 19, wherein the second one or more portions comprises a single frame of the advertisement that is to be played back repeatedly during the advertising segment.
